(19) United States
(12) Patent Application Publication
(10) Pub. No.: US 2005/0072611 A1
(43) Pub. Date: Apr. 7, 2005

(54) Quick release hood of electric scooter

(76) Inventors: Tsang-Mao Lin, Kaohsiung City (TW); Jui-Tien Chen, Kaohsiung City (TW)

Correspondence Address: Leong C. Lei, PMB#1008, 1867 Ygnacio Valley Rd., Walnut Creek, CA, 94598, US

(21) Appl. No.: 10/946,014

(22) Filed: Sep. 22, 2004

(30) Foreign Application Priority Data
Oct. 7, 2003 (TW) 092217960

(51) Int. Cl. B62D 25/10

(52) U.S. Cl. 180/69.2

(57) ABSTRACT

A quick release hood for an electric scooter essentially comprised of a deck locking mechanism and a hood locking mechanism with the former adapted with a locking post and the latter provided with an insertion hole loaded with an resilient member; the locking post being engaged into the insertion hole to remove or reassemble both mechanisms for maintenance or transportation purposes of the electric scooter without requiring any tool by taking advantage of the expansion of the resilient member.

### BACKGROUND OF THE INVENTION

(a) Technical Field of the Invention

The present invention is related to a quick release hood adapted to an electric scooter, and more particularly, to one in which a locking post is adapted to a locking mechanism of the deck while a resilient member is adapted to a hood locking mechanism of the electric scooter allowing quick release and reassembly of the locking mechanism of the deck and the hood locking mechanism in maintenance or transportation.

(b) Description of the Prior Art

As the elderly segment of the total population is increasing and mobility is one of the essential needs in daily life, the development of the electric scooter is appealing The electric scooter is particularly useful for the elderly and the disabled who suffer problems with response and motion. Viewed from the industrial development point of view, the advanced function and technology of the electric scooter and the emerging population of elderly consumer both contribute a rapid growth of the global market.

The electric scooter relates to a transportation means that operates on a scooter loaded battery to drive a controller to control the output from a motor to further drive the rear wheels via a transmission, and then to drive a front wheel to synchronously move for driving the electric scooter.

The prior art of an electric scooter as illustrated in FIG. 1 of the accompanying drawings is essentially comprised of a body 1, a hood 2 and a seat 3. The body 1 includes a steering mechanism 11, a front wheel 12, two rear wheel 13, a pedal deck 14, a power system 15, and a deck locking mechanism 16. The hood 2 is provided to cover up the power system 15, and the seat 3 is provided for riding comfort.

In the event of routine maintenance or disassembly for transportation, the hood 2 is usually removed. A magic tape 17 adhered to the deck locking mechanism 16 and another magic tape 21 adhered inside the hood 2 at where in relation to the magic tape 17 adhered to the deck locking mechanism are used to hold the deck locking mechanism 16 and the hood 2 in position when the hood 2 covers up the deck locking mechanism 16. However, it is usually very difficult to misalign both magic tapes 17, 21 resulting in extremely troublesome in holding both of the hood 2 and the deck locking mechanism 16 in position. Furthermore, both magic tapes 17, 21 may provide excellent adhesion, but as time goes by, the adhesion gets poor after several times of detached for maintenance purpose. Consequently, great noise is heard while driving due to that the impact between the hood 2 and the deck locking mechanism 16. Therefore, in an improved structure of the prior art, the conventional locking with screw is used in lieu of the magic tape as illustrated in FIG. 2. Wherein, a bolt 18 is mounted on the deck locking mechanism 16 while a screw hole is provided on the hood 2 to allow the insertion by the bolt 18 and then the bolt 18 is locked with a nut 22. The fastening though is sufficient to fix the hood 2 to the deck locking mechanism 16, it requires hand tools to remove the nut 22 and the bolt 18; and both of the nut 22 and the bolt 18 are vulnerable to get rusty. Furthermore, improper force exercised in mounting or loosening the nut 22 and/or the bolt 18 will damage the coating on the hood 2.

### SUMMARY OF THE INVENTION

The primary purpose of the present invention is to provide a quick release hood for the electric scooter to easily remove the deck locking mechanism and the hood locking mechanism without any hand tool in the maintenance of the electric scooter. To achieve the purpose, a locking post is incorporated to the deck locking mechanism; an insertion hole is provided on the hood and an resilient member is provided to the circumference of the insertion hole. The locking post from the deck locking mechanism is inserted into the insertion hole on the hood and restricted by the expansion of the resilient member.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of an electric scooter of the prior art.

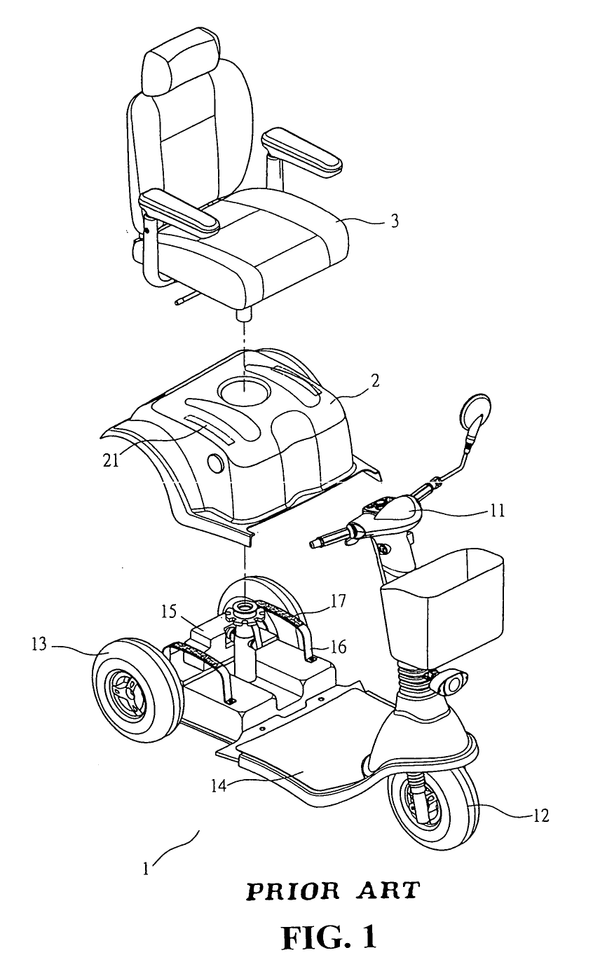

FIG. 2 is an exploded view of a local part of the prior art.

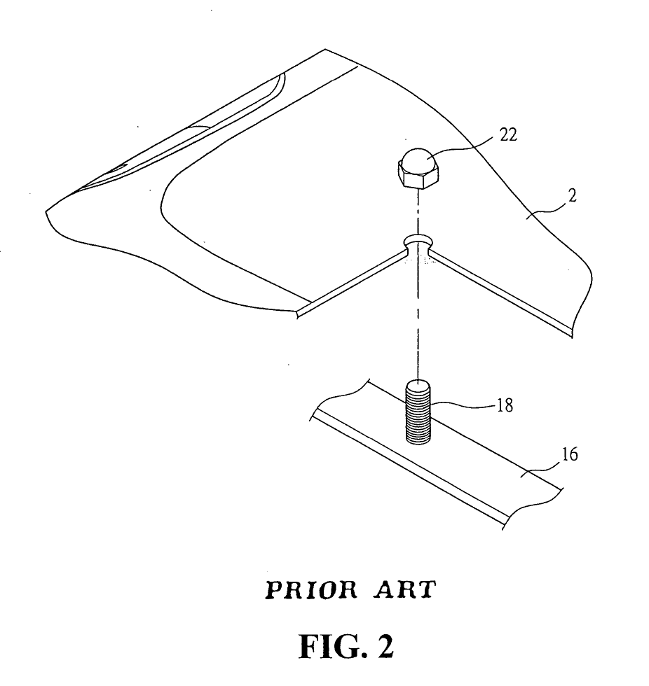

FIGS. 3, 3A and 3B are exploded views of an electric scooter of the present invention.

FIG. 4 is an exploded view of a local part of the present invention.

FIG. 5 is a schematic view showing a frame is incorporated with a locking post of the present invention.

FIG. 6 is a sectional view showing a preferred embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

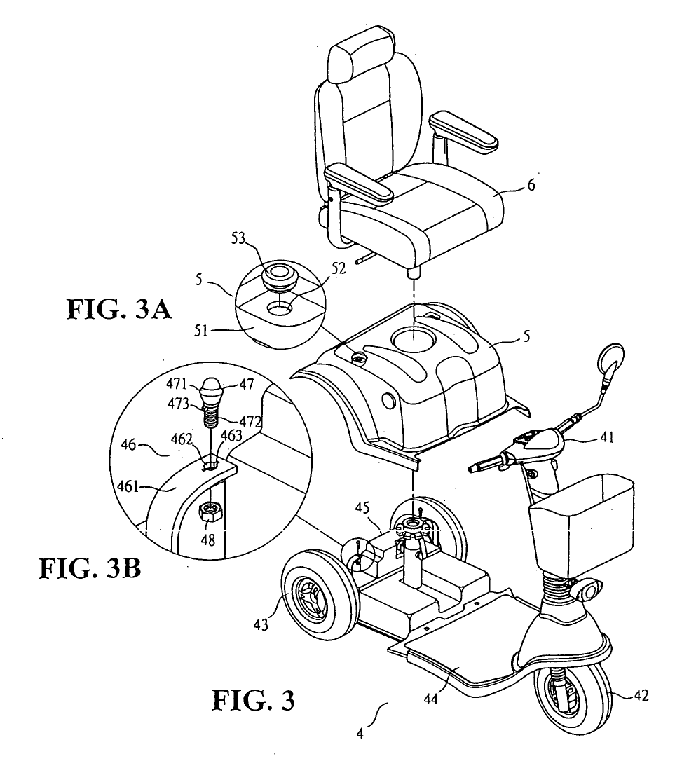

Referring to FIGS. 3, 3A and 3B, a preferred embodiment of the present invention of a body 4, a hood 5 and a seat 6 as found with the prior art. Wherein, the body 4 includes a steering mechanism 41, a front wheel 42, two rear wheels 43, a pedal deck 44, a power system 45, and a deck locking mechanism 46. The hood 5 contains the power system 45, and the seat 6 is provided for riding comfort.

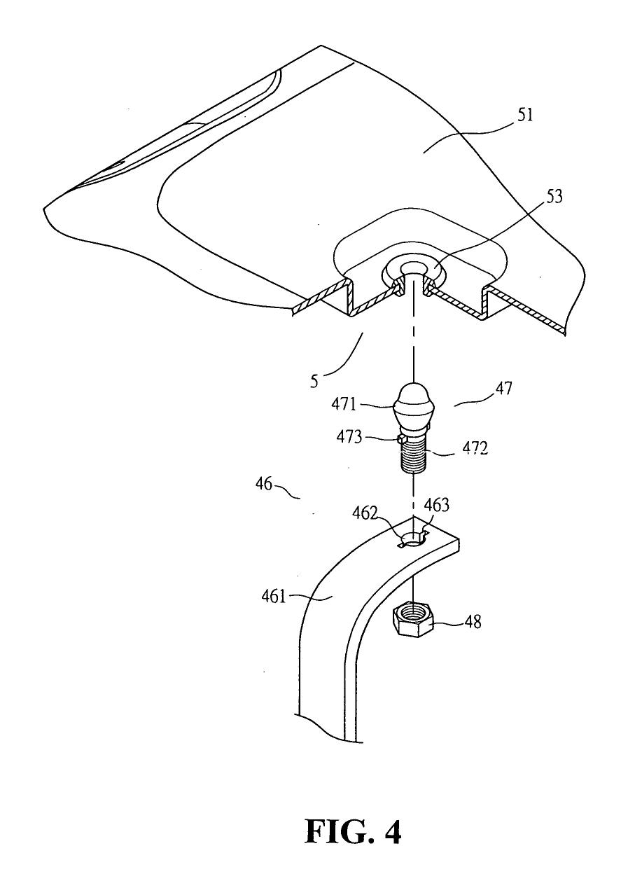

As illustrated in FIG. 4, the quick release is comprised of the deck locking mechanism 46 and a hood locking mechanism 51. Wherein, a locking post 47 is incorporated to the deck locking mechanism 46 and fastened with a nut 48.

The deck locking mechanism 46 includes a frame 461. A restriction hole 462 is disposed at one end of the frame 461 and two guide channels 463 are respectively provided on both sides of the circumference of the restriction hole 462. The locking post 47 is made of a metallic material having its upper section wrapped with a hard plastic material serving as a blocking part 471, and having its lower section provided with a threaded bolt 472. The top of the blocking part 471 is made in a circular head that extends downward and expands into a middle section in diameter greater than that of the circular head, and further extends downward in gradually reducing diameter until it reaches the topper end of the threaded bolt 472. A retainer 473 is each provided to the upper circumference of the threaded bolt 472 at where in relation to the restriction hole 462 of the deck locking mechanism.

The hood locking mechanism 51 is provided with a recess on the hood 5 and an insertion hole 52 is disposed at the bottom of the recess with a resilient member 53 mounted to the circumference of the insertion hole 52. The resilient member 53 is related to a rubber ring having at its center provided with a circular through hole.

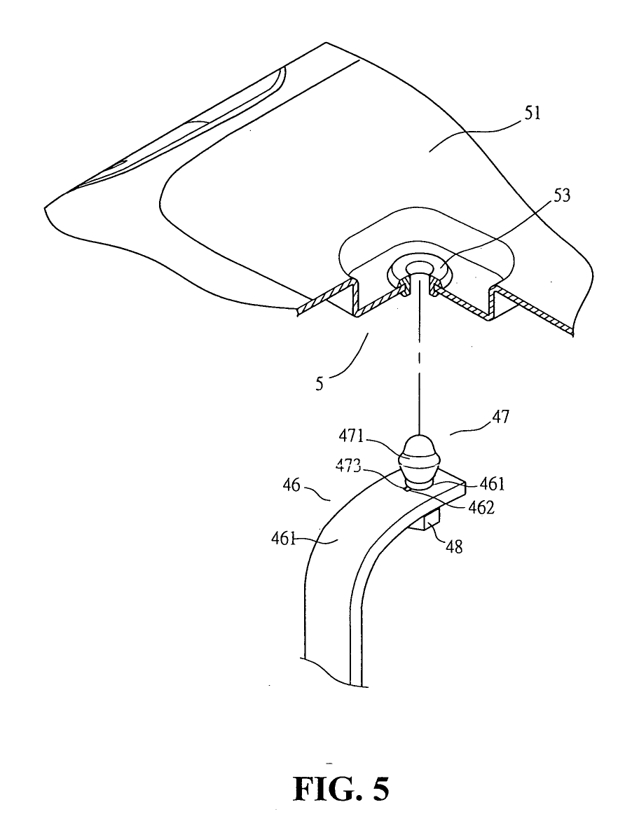

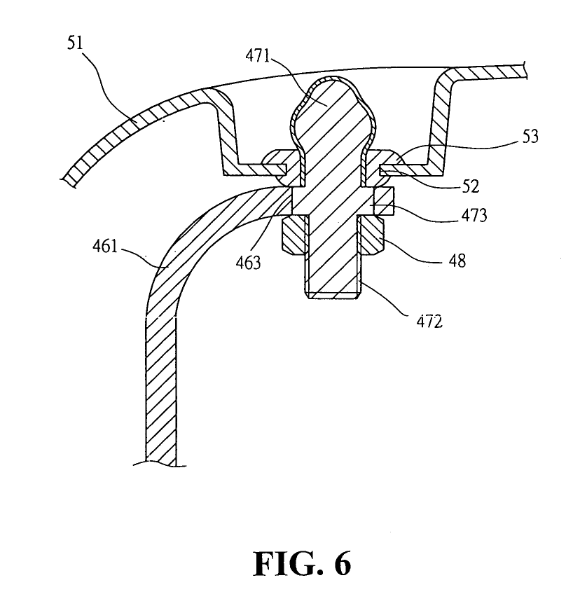

Now referring to FIG. 5, upon assembling the quick release of the present invention. The threaded bolt 472 of the locking post is first inserted into the restriction hole 462 of the frame 461 to the extent that both retainers 473 of the locking post 47 and both guiding channels 473 of the restriction hole 462 are respectively interlocked with each other to prevent the locking post 47 from lateral displacement; and finally the nut 48 is mounted to hold the locking post 47 in position. The assembly described above is done ex-factory. As illustrated in FIG. 6, the hood locking mechanism 51 is provided with the resilient member 53 on the insertion hole of the hood 5. When the hood locking mechanism is incorporated with the locking post 47, the upper end and the lower end of the locking post 47 are both in the same diameter as that of the inner diameter of the resilient member while the middle section of the locking post is in a diameter greater than that of either of the upper or the lower end of the locking post 47. Therefore, when the blocking part 471 penetrates through the resilient member 53, the blocking part 471 for being wrapped up with a hard plastic material is compressed and held in position. Because the resilient member 53 is related to a expandable rubber, it allows the hood locking mechanism 51 to easily adapt to the locking post of the deck locking mechanism, thus to facilitate the removal and reassembly of both the hood locking mechanism and the deck locking mechanism of the electric scooter for the purpose of maintenance or transportation.

The present invention by providing a resilient member to the hood and a locking post to the deck locking mechanism of the electric scooter for the insertion hole disposed on the hood to be incorporated with the locking post of the deck locking mechanism allows easy removal and reassembly of the deck locking mechanism and the hood locking mechanism without the use of any hand tool for maintenance or transportation purpose.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A quick release for an electric scooter comprised of a deck locking mechanism provided on a frame and a locking mechanism provided on a hood is characterized by that a locking post being incorporated to the deck locking mechanism; an insertion hole being disposed on the hood locking mechanism; an resilient member being mounted to the insertion hole; the locking post being inserted through the insertion hole on the hood; and the resilient expansion of the resilient member being used to remove or reassemble both of the deck locking mechanism and the hood locking mechanism without any hand tool.

2. A quick release for an electric scooter as claimed in claim 1, wherein, the locking post is made of metallic material wrapped at its upper section with a hard plastic material serving as the blocking part.

3. A quick release for an electric scooter as claimed in claim 1, wherein, the upper end of the blocking part of the locking post is made in a round end that extends downward to form a middle section in larger diameter; and the middle section extends further downward and gradually reducing in diameter to reach the upper end of a bolt.

4. A quick release for an electric scooter as claimed in claim 1, wherein, the resilient member relates to a ring with inherited resilience.
